(19) United States
(12) Patent Application Publication
(10) Pub. No.: US 2020/0210896 A1
(43) Pub. Date: Jul. 2, 2020

(54) METHOD AND SYSTEM FOR REMOTE TRAINING OF MACHINE LEARNING ALGORITHMS USING SELECTED DATA FROM A SECURED DATA LAKE

(71) Applicant: Otonomo Technologies Ltd., Even Yehuda (IL)

(72) Inventors: Yosef Haim ITZKOVICH, Raanana (IL); Nimrod PARASOL, Tel-Aviv (IL)

(73) Assignee: Otonomo Technologies Ltd., Even Yehuda (IL)

(21) Appl. No.: 16/703,878

(22) Filed: Dec. 5, 2019

Related U.S. Application Data
(60) Provisional application No. 62/784,896, filed on Dec. 26, 2018.

(51) Int. Cl. G06N 20/00; G06K 9/62; G06F 21/62; G06F 3/0482

(52) U.S. Cl. CPC G06N 20/00; G06F 3/0482; G06F 21/6254; G06K 9/6262

(57) ABSTRACT

A system and a method for remote training of a machine learning algorithm using selected data from a secured data lake are provided herein. The method may include the following steps: inputting client parameters onto a secured server having said secured data lake; collating raw data stored within said secured data lake, according to said client parameters, to yield selected data, wherein said selected data and said raw data are inaccessible to said client; uploading said machine learning algorithm from said client to said secured server; and training said machine learning algorithm on said secured server, using said selected data, to yield a trained machine learning algorithm.

### CROSS-REFERENCE TO RELATED APPLICATIONS

This application claims the benefit of U.S. Provisional Patent Application No. 62/784,896, filed on Dec. 26, 2018, which is incorporated herein by reference in its entirety.

### FIELD OF THE INVENTION

The present invention relates generally to the field of data processing and, more particularly, to training machine learning algorithms using large databases.

### BACKGROUND OF THE INVENTION

Machine learning algorithms, also known as machine learning models, are rapidly increasing in popularity owing to their applicability for use in most technical fields. The effectiveness and accuracy of any given machine learning algorithm is, however, generally denoted by how well it has been trained or to how much raw data the algorithm has been exposed. Indeed, a machine learning algorithm which has only been exposed to a small amount of sample data will typically lack the resolution to adequately comprehend and/or characterize data events, particularly those that occur infrequently. Accordingly, in order to make proper use of their algorithms, organizations and companies utilizing machine learning techniques have an unyielding, potentially evolving, requirement for substantial amounts of relevant data upon which to train their algorithms.

Raw data on such a scale is, however, often difficult to collect or gain access to, particularly so for smaller or less advanced businesses. Further, even for larger and more advanced businesses, managing and processing data on such a scale may require substantial infrastructure and thus may be rendered highly cost prohibitive. It is also the case in some technical fields that the requisite training data may relate to individuals and may, for example, be subject to legislative or regulatory provisions governing the exchange of personal and/or sensitive confidential information.

It is, therefore, an object of the present invention to propose a means for granting businesses remote access to raw data upon which to train their machine learning algorithms while simultaneously adhering to relevant legislative requirements. It is a further object of the present invention to achieve the aforementioned without requiring businesses to download vast amounts of potentially confidential data, thereby obviating any liability for improper data handling or security.

### SUMMARY OF THE INVENTION

A method for remote training of a machine learning algorithm using selected data from a secured data lake is disclosed herein. The method comprises: inputting client parameters onto a secured server having said secured data lake; collating raw data stored within said secured data lake, according to said client parameters, to yield selected data, wherein said selected data and said raw data are inaccessible to said client; uploading said machine learning algorithm from said client to said secured server; and training said machine learning algorithm on said secured server, using said selected data, to yield a trained machine learning algorithm.

A secured server for remote training of a machine learning algorithm is also disclosed. The secured server comprises: a secured data lake configured to receive and store raw data from a plurality of raw data sources; a user interface connected to said secured data lake and configured to receive client parameters input by a client; a data selector configured to collate raw data stored within said secured data lake, according to said client parameters, to yield selected data, wherein said selected data and said raw data are inaccessible to said client; an algorithm uploader configured to receive and retain said machine learning algorithm uploaded by said client to said secured server; and a training module configured to train said machine learning algorithm, on said secured server, using said selected data, to yield a trained machine learning algorithm.

Advantages of the present invention are set forth in detail in the following description.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating non-limiting exemplary architecture of a secured server configured for data selection according to client parameters in accordance with some embodiments of the present invention;

FIG. 2 is a block diagram illustrating non-limiting exemplary architecture of a secured server for remote training of machine learning algorithms in accordance with some embodiments of the present invention; and,

FIG. 3 is a high-level flowchart illustrating non-limiting exemplary method in accordance with some embodiments of the present invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

The following term definitions are provided to aid in construal and interpretation of the invention.

The term “machine learning”, as used herein, refers generally to the capacity of a computer system, for example such as one executing a particular algorithm or model, to perform a specific task in the absence of receiving explicit instructions mandating performance of the same. The computer system instead observes patterns within subsets of data, collectively referred to as “training data” (i.e., the data upon which a machine learning algorithm is based/raised), and draws inferences from the observed patterns in the form of predictions or decisions relating to discrete or interrelated strings of data. These predictions or decisions may then be realized and acted upon, generally without requiring further human intervention or input.

The term “secured server” refers generally to a computer system operable to manage access to a centralized resource or service in a networked environment, and in particular to such systems where access to said resource or service requires approval or a right of access (i.e., the system prevents unrestricted access).

The term “data lake” refers generally to a repository of data, typically stored in a raw or native (i.e., unprocessed) format. The data may be collected from a plurality of disparate sources and stored on a variety of different data storage mediums (e.g., a hard disk drive) in a variety of different data formats (e.g., JPEG, PNG, and the like). In some circumstances, the data contained within a data lake may constitute, or otherwise contain, sensitive confidential information and may be subject to legislative provisions governing how the data may be shared or accessed.

The term “neutral server” refers generally to a regulatory initiative instigated by automotive industry organizations throughout Europe. A neutral server acts typically as a data repository (e.g., a networked server) and facilitates the sharing of data, particularly automotive data, collected from a variety of data originators (e.g., connected vehicles, road-bound infrastructure, and the like). Pursuant to stipulated regulatory and legislative requirements, each neutral server must be operated and financed by an independent party (e.g., a party without obligations or business interests within the automotive sector) and access to data (e.g., personal and/or sensitive data) must be restricted, as appropriate. In the context of the present invention, the disclosed secured server may be a neutral server.

The term “client parameters”, as used herein, refers generally to a set of identifying features and/or variables uniquely relating to a specific client, individual or user that may be used to profile and isolate relevant data from within a data repository (e.g., a data lake). Client parameters may, for example, define the area or technical field in which a business operates (e.g., the parameters may stipulate that the business manufacturers carburetors) and may be used as basis to select relevant data from within the data repository (e.g., the parameters may be used as basis to select relevant data that includes the lifespan of carburetors for a specific model of a vehicle).

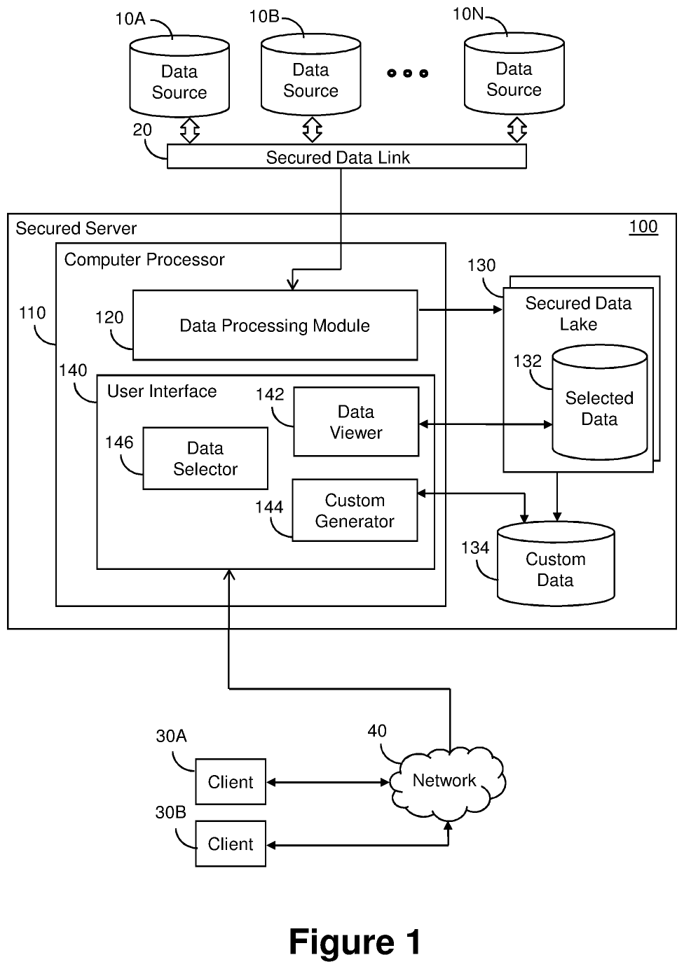

FIG. 1 is a block diagram illustrating a non-limiting exemplary architecture of a secured server configured for data selection according to client parameters in accordance with some embodiments of the present invention. Secured server 100 may be communicatively connected, for example via wired or wireless secured data link 20, to a plurality of data sources/originators 10A, 10B . . . 10N. Each data source/originator 10A, 10B . . . 10N may be operable to collect and store data, typically in a raw or native format, from a variety of systems such as, for example, the sensor systems on a connected vehicle (e.g., Global Positioning System (GPS), accelerometer, voltage sensors, and the like). Secured server 100 may also be communicatively connected, for example via wired or wireless network 40, to one or more clients 30A, 30B, each of whom may have an interest in utilizing data originating from one or more of the data source/originators 10A, 10B . . . 10N.

Secured server 100 may include one or more computer processors 110 operable to run one or more data processing modules 120. Data transferred to secured server 100 from data source/originators 10A, 10B . . . 10N may be processed by data processing modules 120 (e.g., by grouping, reformatting, normalizing and/or categorized the data) and then stored in a secured data lake 130. In circumstances where data received from data source/originators 10A, 10B . . . 10N includes sensitive and/or confidential information, the data may additionally be anonymized so as to adhere to legislative data handling requirements. In alternative embodiments, data transferred to secured server 100 from data source/originators 10A, 10B . . . 10N may be retained in an entirely unprocessed state (i.e., a native or raw format) and stored directly in secured data lake 130.

Secured server 100 may further include a user/client interface 140 operated by the one or more computer processors 110. User/client interface 140 may be operable to receive inputs in the form of client parameters and/or designation commands from one or more clients 30A, 30B. Computer processors 110 may be operable, in response to client parameters input by clients 30A, 30B, to collate data stored in secured data lake 130 into a smaller subset of selected data 132. This subset of selected data 132 may be of increased relevance to clients 30A, 30B and may be computationally or manually selected in accordance with the client parameters input into user/client interface 140. User/client interface 140 may also include a data viewer 142 configured to provide clients 30A, 30B with an overview of a data stored in secured data lake 130 and/or an overview of selected data 132. In order to comply with legislative data handling requirements, this overview may include, for example, lists of overarching data categories (i.e., data schema) and may be partially or fully anonymized. User/client interface 140 may further include a custom generator 144 configured to generate, for example responsive to input from clients 30A, 30B using data selector 146, custom data 134. Custom data 134 may be selected by clients 30A, 30B to include either all, or a subset of, selected data 132 and thereby may enable clients 30A, 30B to uniquely tailor custom data 134 specifically to their training requirements (e.g., for the purposes of training a machine learning algorithm using highly specified sets of data).

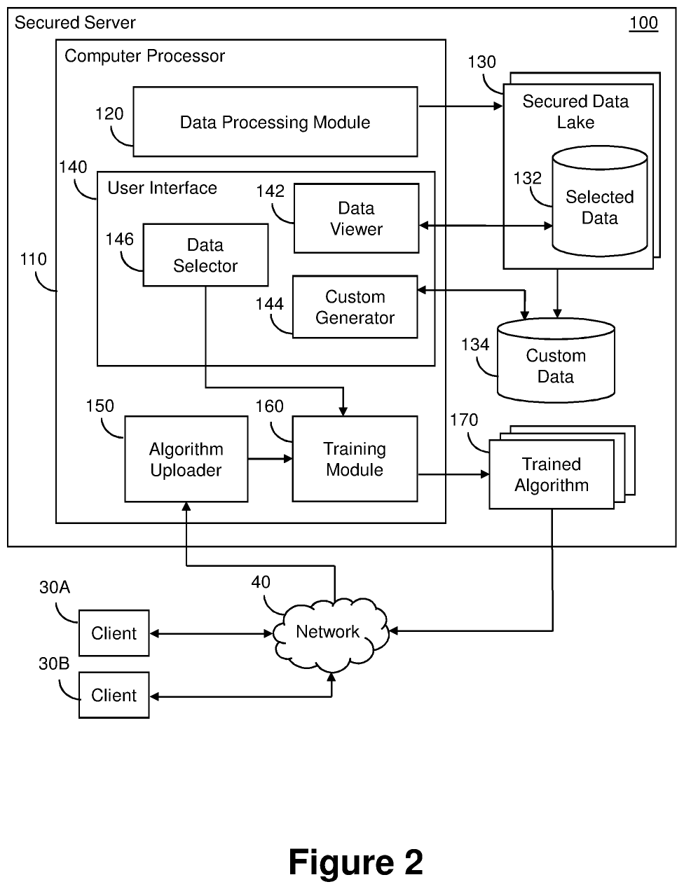

FIG. 2 is a block diagram illustrating a non-limiting exemplary architecture of a secured server for remote training of machine learning algorithms in accordance with some embodiments of the present invention. Secured server 100 may additionally include one or more algorithm uploaders 150 configured for implementation by computer processor 110. Algorithm uploaders 150 may be configured to receive, for example following wired or wireless transmission over network 40, one or more machine learning algorithms whose remote training is sought by clients 30A, 30B. Following receipt of an untrained machine learning algorithm, algorithm uploaders 150 may transfer the untrained machine learning algorithm to a training module 160 where it is optionally stored locally. Data selected by clients 30A, 30B using data selector 146 (i.e., selected data 132 and/or custom data 134) may then be accessed by training module 160 and used for the purposes of improving the machine learning algorithm. This may include training, validating and/or testing the machine learning algorithm (e.g., iteratively over numerous successive cycles) to yield one or more trained algorithms 170 (i.e., algorithms which have been trained and tailored according the needs and requirements of clients 30A, 30B). When the training process is completed, trained algorithms 170 may be returned for use by their respective client 30A, 30B, for example via transmission over wired or wireless network 40.

Advantageously, secured server 100 may be compliant with legislative data handling and privacy regulations, such as the European Union general data protection regulation (GDPR) or similar Secured server 100 may thus enable clients 30A, 30B to efficiently and accurately train a machine learning algorithm at a remote location within a protected ecosystem that comprises a highly comprehensive source of raw and/or processed data.

According to some embodiments of the present invention, data processing modules 120 may be operable to automatically group, format, normalize and/or categorized the data in secured data lake 130 using machine learning techniques. In alternative embodiments, raw data held within secured data lake 130 may be grouped, formatted, normalized and/or categorized the data by human experts.

Advantageously, embodiments of the present invention provide a user interface 140 to view data stored in secured data lake 130 and/or an overview of selected data 132 so that customers may intuitively understand which portions of the available data are relevant to their requirements and how they may use it.

As will be appreciated by those skilled in the art, the aforementioned proposed features enable machine learning algorithms to be remotely trained using data wholly stored at a remote location (i.e., training over “the cloud”). A highly beneficial consequence of this arrangement is that data used for the purposes of training the machine learning algorithms need not ever be transmitted outside of the secured server 100. This, in turn, obviates any liability for the data on the part of clients 30A, 30B (e.g., legislative or regulatory liability). It also allows for access to significantly larger repositories of data, and further saves on transmission bandwidth (i.e., as the data need not be transmitted to clients 30A, 30B).

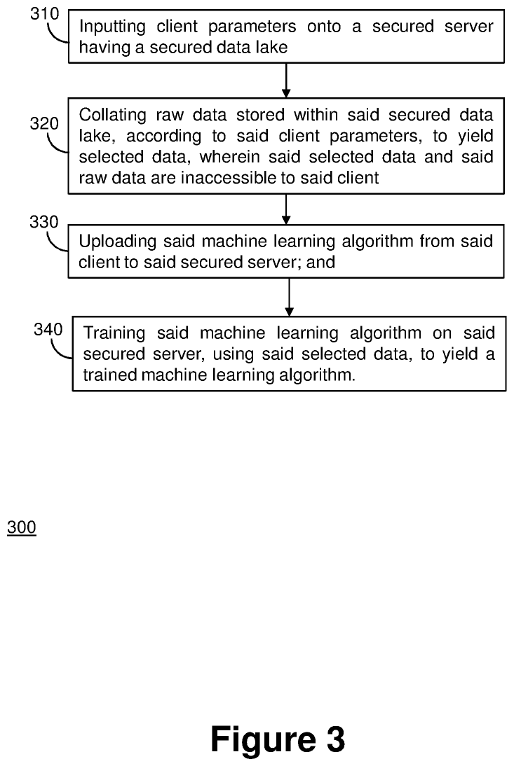

FIG. 3 is a high-level flowchart illustrating a non-limiting exemplary method in accordance with some embodiments of the present invention. Method 300 for remote training of a machine learning algorithm using selected data from a secured data lake is provided herein. Method 300 may include the following steps: inputting a client profile onto a secured server having a secured data lake 310; collating raw data stored within said secured data lake, according to said client profile, to yield selected data, wherein said selected data and said raw data are inaccessible to said client 320; uploading said machine learning algorithm from said client to said secured server 330; and training said machine learning algorithm on said secured server, using said selected data, to yield a trained machine learning algorithm 340.

According to some embodiments, the method may further comprise generating custom data in accordance with designation commands input by the client, wherein said training further uses at least some of said custom data. The system may additionally comprise a custom generator configured to generate custom data in accordance with designation commands input by the client onto the user interface.

According to some embodiments, raw data stored within the secured data lake may be organized into a plurality of data categories which may be presented to the client. Further, designation commands input by the client, for example using the user interface, may comprise a custom selection of one or more of said data categories. The system may additionally comprise a data viewer operable to present the plurality of data categories to the client for custom selection.

According to some embodiments, one or more of the data categories may be anonymized prior to being presented to the client for custom selection, for example on the data viewer.

According to some embodiments, the trained machine learning algorithm may be sent to the client. This may be achieved by transmitting the algorithm, via wired or wireless medium, over a network.

According to some embodiments, the training may further comprise applying the machine learning algorithm to a validation or test dataset to determine the effectiveness of the training. This verification process may be implemented using the training module.

It should be noted that the method according to some embodiments of the present invention may be stored as instructions in a computer readable medium to cause processors, such as central processing units (CPU) to perform the method. Additionally, the method described in the present disclosure can be stored as instructions in a non-transitory computer readable medium, such as storage devices which may include hard disk drives, solid state drives, flash memories, and the like. Additionally, non-transitory computer readable medium can be memory units.

In order to implement the method according to some embodiments of the present invention, a computer processor may receive instructions and data from a read-only memory or a random-access memory or both. At least one of aforementioned steps is performed by at least one processor associated with a computer. The essential elements of a computer are a processor for executing instructions and one or more memories for storing instructions and data. Generally, a computer will also include, or be operatively coupled to communicate with, one or more mass storage devices for storing data files. Storage modules suitable for tangibly embodying computer program instructions and data include all forms of non-volatile memory, including by way of example semiconductor memory devices, such as EPROM, EEPROM, and flash memory devices and also magneto-optic storage devices.

As will be appreciated by one skilled in the art, some aspects of the present invention may be embodied as a system, method or computer program product. Accordingly, some aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, JavaScript Object Notation (JSON), C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or portion diagrams of methods, apparatus (systems) and computer program products according to some embodiments of the invention. It will be understood that each portion of the flowchart illustrations and/or portion diagrams, and combinations of portions in the flowchart illustrations and/or portion diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or portion diagram portion or portions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or portion diagram portion or portions.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or portion diagram portion or portions.

The aforementioned flowchart and diagrams illustrate the architecture, functionality, and operation of possible implementations of systems, methods and computer program products according to various embodiments of the present invention. In this regard, each portion in the flowchart or portion diagrams may represent a module, segment, or portion of code, which comprises one or more executable instructions for implementing the specified logical function(s). It should also be noted that, in some alternative implementations, the functions noted in the portion may occur out of the order noted in the figures. For example, two portions shown in succession may, in fact, be executed substantially concurrently, or the portions may sometimes be executed in the reverse order, depending upon the functionality involved. It will also be noted that each portion of the portion diagrams and/or flowchart illustration, and combinations of portions in the portion diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

1. A method for remote training of a machine learning algorithm using selected data from a secured data lake, the method comprising:
inputting client parameters onto a secured server having said secured data lake;
collating raw data stored within said secured data lake, according to said client parameters, to yield selected data, wherein said selected data and said raw data are inaccessible to said client;
uploading said machine learning algorithm from said client to said secured server; and
training said machine learning algorithm on said secured server, using said selected data, to yield a trained machine learning algorithm.

2. The method according to claim 1, further comprising generating custom data in accordance with designation commands input by said client, wherein said training further uses at least some of said custom data.

3. The method according to claim 2, wherein said raw data stored within said secured data lake is organized into a plurality of data categories which are presented to said client, and wherein said designation commands input by said client comprise custom selection of one or more of said data categories.

4. The method according to claim 3, wherein one or more of said data categories are anonymized prior to being presented to said client.

5. The method according to claim 1, further comprising sending said trained machine learning algorithm to said client over a network.

6. The method according to claim 1, wherein said training further comprises applying said machine learning algorithm to a validation or test dataset to determine the effectiveness of said training.

7. A secured server for remote training of a machine learning algorithm, the secured server comprising:
a secured data lake configured to receive and store raw data from a plurality of raw data sources;
a user interface connected to said secured data lake and configured to receive client parameters input by a client;
a data selector configured to collate raw data stored within said secured data lake, according to said client parameters, to yield selected data, wherein said selected data and said raw data are inaccessible to said client;
an algorithm uploader configured to receive and retain said machine learning algorithm uploaded by said client to said secured server; and
a training module configured to train said machine learning algorithm, on said secured server, using said selected data, to yield a trained machine learning algorithm.

8. The secured server according to claim 7, further comprising a custom generator configured to generate custom data in accordance with designation commands input by said client onto said user interface, wherein said training further uses at least some of said custom data.

9. The secured server according to claim 8, further comprising a data viewer, wherein said raw data stored within said secured data lake is organized into a plurality of data categories which are presented to said client on said data viewer, and wherein said designation commands input by said client onto said user interface comprise custom selection of one or more of said data categories.

10. The secured server according to claim 9, wherein one or more of said data categories are anonymized prior to being presented to said client on said data viewer.

11. The secured server according to claim 7, further configured to send said trained machine learning algorithm to said client over a network.

12. The secured server according to claim 7, wherein said training module is further configured to apply said machine learning algorithm to a validation or test dataset to determine the effectiveness of said training implemented by said training module.

13. A non-transitory computer readable medium comprising a set of instructions that, when executed, cause at least one computer processor to:
receive and store raw data from a plurality of raw data sources on a secured data lake associated with a secure server;
receive client parameters input by a client via a user interface;
collate raw data stored within said secured data lake, according to said client parameters, to yield selected data, wherein said selected data and said raw data are inaccessible to said client;
receive and retain said machine learning algorithm uploaded by said client to said secured server; and
train said machine learning algorithm, on said secured server, using said selected data, to yield a trained machine learning algorithm.

14. The non-transitory computer readable medium according to claim 13, further comprising instructions that, when executed, cause said at least one computer processor to generate custom data in accordance with designation commands input by said client onto said user interface, wherein said training further uses at least some of said custom data.

15. The non-transitory computer readable medium according to claim 14, wherein said raw data stored within said secured data lake is organized into a plurality of data categories which are presented to said client via a data viewer, and wherein said designation commands input by said client onto said user interface comprise custom selection of one or more of said data categories.

16. The non-transitory computer readable medium according to claim 15, wherein one or more of said data categories are anonymized prior to being presented to said client on said data viewer.

17. The non-transitory computer readable medium according to claim 13, further comprising instructions that, when executed, cause said at least one computer processor to send said trained machine learning algorithm to said client over a network.

18. The non-transitory computer readable medium according to claim 13, further comprising instructions that, when executed, cause said at least one computer processor to apply said machine learning algorithm to a validation or test dataset to determine the effectiveness of said training implemented by said training module.
